(19) United States
(12) Patent Application Publication
(10) Pub. No.: US 2026/0280391 A1
(43) Pub. Date: Sep. 17, 2026

(54) HOLDER FOR A HELICAL BRUSH AND A GROUNDING BRUSH ASSEMBLY

(71) Applicant: AKTIEBOLAGET SKF, GOTEBORG (SE)

(72) Inventors: Mathieu HUBERT, Ann Arbor, MI (US); Gene Arthur KOVACS, Brighton, MI (US); David Christopher RYBSKI, White Lake, MI (US); William GEORGE, Ypsilanti, MI (US)

(21) Appl. No.: 19/075,877

(22) Filed: Mar. 11, 2025

(51) Int. Cl. H02K 11/40; H01R 39/38

(52) U.S. Cl. CPC H02K 11/40; H01R 39/38

(57) ABSTRACT

A holder for a grounding brush assembly includes a circular tubular base having a centerline, a first and second axial ends spaced apart along the centerline, an inner circumferential surface extending between the axial ends and defining a bore configured to receive a portion of the fixed shaft, and a cylindrical outer circumferential surface extending between the axial ends and sized to receive the helical brush. A first flange extends radially outwardly from the first axial end of the base and is engageable with an axial end of the helical brush so as to retain the brush disposed about the base. A second flange extends radially outwardly from the second axial end of the base and is engageable with another axial end of the helical brush or a centering bearing disposed on the base between the brush and the second flange to retain the brush disposed about the base.

### BACKGROUND OF THE INVENTION

The present invention relates to grounding devices for bearings, and more particularly to grounding brush assemblies for shunting current away from bearings.

In electric machines, such as an electric motor, a generator, etc., the machine typically includes a shaft rotatable about a central axis, an outer housing and at least one bearing connecting the shaft to a housing. Such bearings generally include an inner ring mounted on the rotatable shaft, an outer ring disposed about the inner ring and engaged with the housing, and a plurality of rolling elements disposed between the inner and outer rings. During operation, electric charge may accumulate on the shaft, which can generate an electric current that passes from the shaft, through the bearing and into the outer housing. These currents can cause damage to the raceways of the inner and outer rings as well as to the rolling elements.

In order to avoid damage to the bearings, it is known to provide a grounding brush assembly that provides a conductive path between the shaft and the housing in order to shunt current away from the bearing(s). Such a grounding brush assembly typically includes a bracket or holder connected with the housing and a brush attached to the bracket/holder and including a plurality of conductive fibers extending radially inwardly from the holder and contacting the outer surface of the shaft, or a sleeve or other member mounted on the shaft. Alternatively, the holder may be mounted on the rotatable shaft and include a plurality of radially-outwardly directed fibers engaged with an inner circumferential surface of the housing.

### SUMMARY OF THE INVENTION

In an aspect, the present invention is a holder for a grounding brush assembly for an electric machine, the grounding brush assembly including a helical conductive brush with a helical retainer having opposing axial ends and a plurality of conductive fibers extending radially outwardly from the retainer. The electric machine includes a hollow shaft, the hollow shaft being rotatable about a central axis and having a bore, and a fixed shaft extending through the bore of the hollow shaft. The holder comprises a circular tubular base having a centerline, a first axial end and second axial end spaced apart along the centerline, an inner circumferential surface extending between the first and second axial ends and defining a bore configured to receive a portion of the fixed shaft, and a cylindrical outer circumferential surface extending between the first and second axial ends and sized to receive the helical brush. A first flange extends radially outwardly from the first axial end of the base and is engageable with an axial end of the helical brush so as to retain the helical brush disposed about the base. A second flange extends radially outwardly from the second axial end of the base and is engageable with another axial end of the helical brush or a centering bearing disposed on the base between the helical brush and the second flange to retain the helical brush disposed about the base.

Preferably, the first flange is integrally formed with the first axial end of the base and the second flange is integrally formed with the second axial end of the base, but may be provided by separately attached members. In order to assemble the brush on the holder, the second flange is preferably bent radially outwardly from the second axial end of the tubular base after installation of the helical brush about the base. Further, the first flange preferably includes a retainer tab portion extending axially from a remainder of the first flange and engageable with the first axial end of the brush retainer so as to prevent angular displacement of the helical brush about the centerline. Furthermore, the first flange is annular and the second flange is either annular or includes a plurality of arcuate tabs spaced circumferentially about the centerline.

In another aspect, the present invention is a grounding brush assembly for an electric machine, the electric machine including a hollow shaft, the hollow shaft being rotatable about a central axis and having a bore, and a fixed shaft extending through the bore of the hollow shaft. The grounding brush assembly includes the holder as described above and further includes a helical conductive brush disposed about the cylindrical outer surface of the tubular base between the first and second flanges. The brush includes a helical retainer and a plurality of conductive fibers extending radially outwardly from the retainer and engageable with the inner circumferential surface such that at least one electrically conductive path extends from the hollow shaft, through the helical brush and the holder, and to the fixed shaft. The grounding brush assembly may also include a centering bearing disposed about the tubular base.

In a further aspect, the present invention is a method of forming a grounding brush assembly. The method comprises the steps of: providing a helical conductive brush including a helical retainer and a plurality of conductive fibers extending radially outwardly from the retainer; providing an elongated circular tube having a centerline, opposing first and second axial ends, an inner circumferential surface defining a circular bore, and an outer circumferential surface; forming a first flange on the first axial end of the tube such that the first flange extends radially outwardly from the outer surface of the tube; axially displacing the helical brush over the second axial end of the tube until the brush is disposed entirely about the outer circumferential surface of the tube; and forming a second flange on the second axial end of the tube such that the second flange extends radially outwardly from the outer surface of the tube, the first and second flanges retaining the helical brush about the tube.

### BRIEF DESCRIPTION OF THE SEVERAL VIEWS OF THE DRAWING

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of an electric machine with a grounding brush assembly including a holder in accordance with the present invention;

FIG. 2 is a perspective view of the grounding brush assembly with a holder in accordance with a first construction;

FIG. 3 is a side plan view of the grounding brush assembly of FIG. 2;

FIG. 4 is an axial cross-sectional view of the grounding brush assembly of FIG. 2, shown with an optional spacer ring;

FIG. 5 is a perspective view of the grounding brush assembly including a second construction of the holder having a second flange formed of arcuate tabs, the assembly including a spacer ring;

FIG. 6 is an exploded, perspective view of the grounding brush assembly with the second construction holder and a spacer ring;

FIG. 7 is a perspective view of a grounding brush assembly with the second construction holder, a spacer ring and a centering bearing;

FIG. 8 is a side plan view of the grounding brush assembly of FIG. 7;

FIG. 9 is a perspective view of a tubular base, shown prior to forming the second flange of the second construction; and

FIG. 10 is a perspective view of the second construction holder in which the second flange further includes a retainer tab portion for preventing angular displacement of a brush.

### DETAILED DESCRIPTION OF THE INVENTION

Certain terminology is used in the following description for convenience only and is not limiting. The words "inner", "inwardly" and "outer", "outwardly" refer to directions toward and away from, respectively, a designated centerline or a geometric center of an element being described, the particular meaning being readily apparent from the context of the description. Further, as used herein, the words "connected" and “coupled” are each intended to include direct connections between two members without any other members interposed therebetween and indirect connections between members in which one or more other members are interposed therebetween. The terminology includes the words specifically mentioned above, derivatives thereof, and words of similar import.

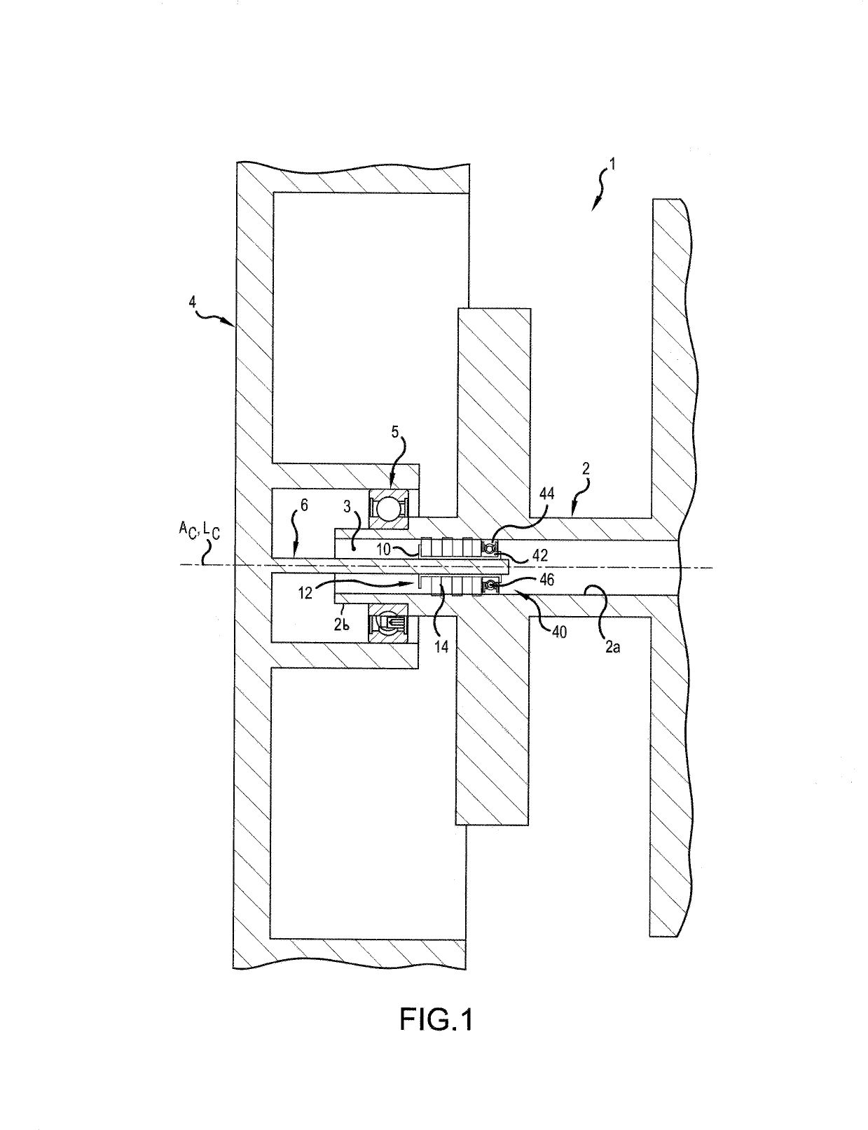

Referring now to the drawings in detail, wherein like numbers are used to indicate like elements throughout, there is shown in FIGS. 1-10 a holder 10 of a grounding brush assembly 12 for an electric machine 1. The grounding brush assembly 12 includes a helical conductive brush 14 with a helical retainer 16 having opposing axial ends 16a,16b and a plurality of electrically conductive fibers 18 extending radially outwardly from the retainer 16. The electric machine 1 preferably includes a hollow shaft 2 rotatable about a central axis A_{C}and having an inner circumferential surface 2a defining a hollow bore 3 and an outer circumferential surface 2b, an outer housing 4, at least one bearing 5 rotatably coupling the shaft 2 with the housing 4, and a fixed shaft 6 extending through the bore 3 of the hollow shaft 2 and being electrically grounded. Preferably, the electric machine 1 is a motor for an electric vehicle, but may be any other appropriate electrical device which includes one or more bearings 5 for supporting a rotating shaft 2, for example, a motor for an industrial machine, a generator, etc. The holder 10 basically comprises a circular tubular base 20 with opposing first and second axial ends 20a, 20b, a first flange 22 at the first axial end 20a of the base 20 and a second flange 24 at the second axial end 20b of the base 20.

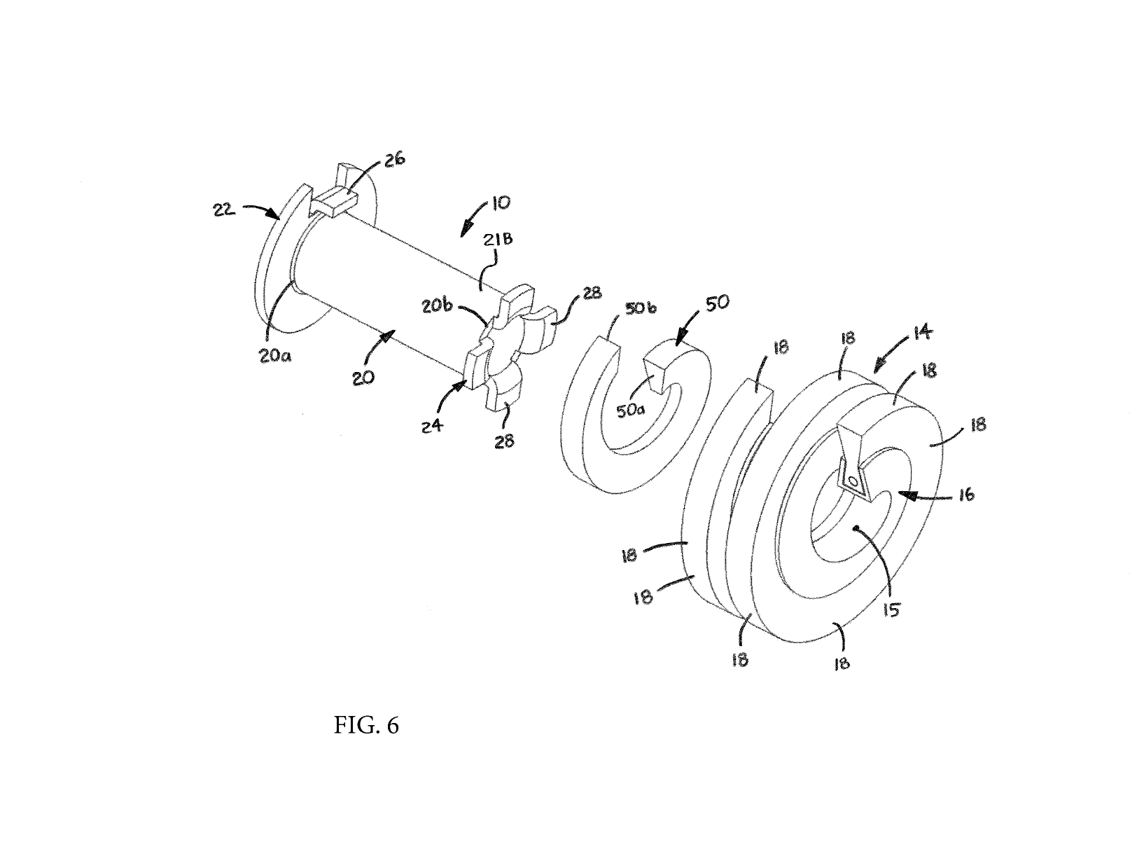

More specifically, the circular tubular base 20 has a centerline L_{C}, the first and second axial ends 20a, 20b being spaced apart along the centerline L_{C}, an inner circumferential surface 21A and a cylindrical outer circumferential surface 21B each extending between the two axial ends 20a, 20b. The inner circumferential surface 21A defines a bore 23 configured to receive a portion of the fixed shaft 6 and is preferably diametrically sized to engage the outer surface (not indicated) of the shaft 6 with a friction fit to axially retain the holder 10. Also, the cylindrical outer circumferential surface 21B is sized to receive the helical brush 14 and is preferably diametrically greater or larger than a central bore 15 (FIG. 6) of the helical brush 14. As such, the brush 14 must be slightly dilated during assembly onto the base 20, which ensures a sufficient contact pressure between the brush retainer 16 and the base 20 to establish adequate electrical conduction between the brush 14 and the holder 10. Preferably, the circular tubular base 20, as well as the portions of the base 20 which provide the flanges 22, 24 as discussed below, is/are fabricated from a section or length of circular tube stock, either commercially available or specially manufactured, and formed of an electrically conductive metallic material, such as for example, aluminum, low carbon steel, stainless steel, etc.

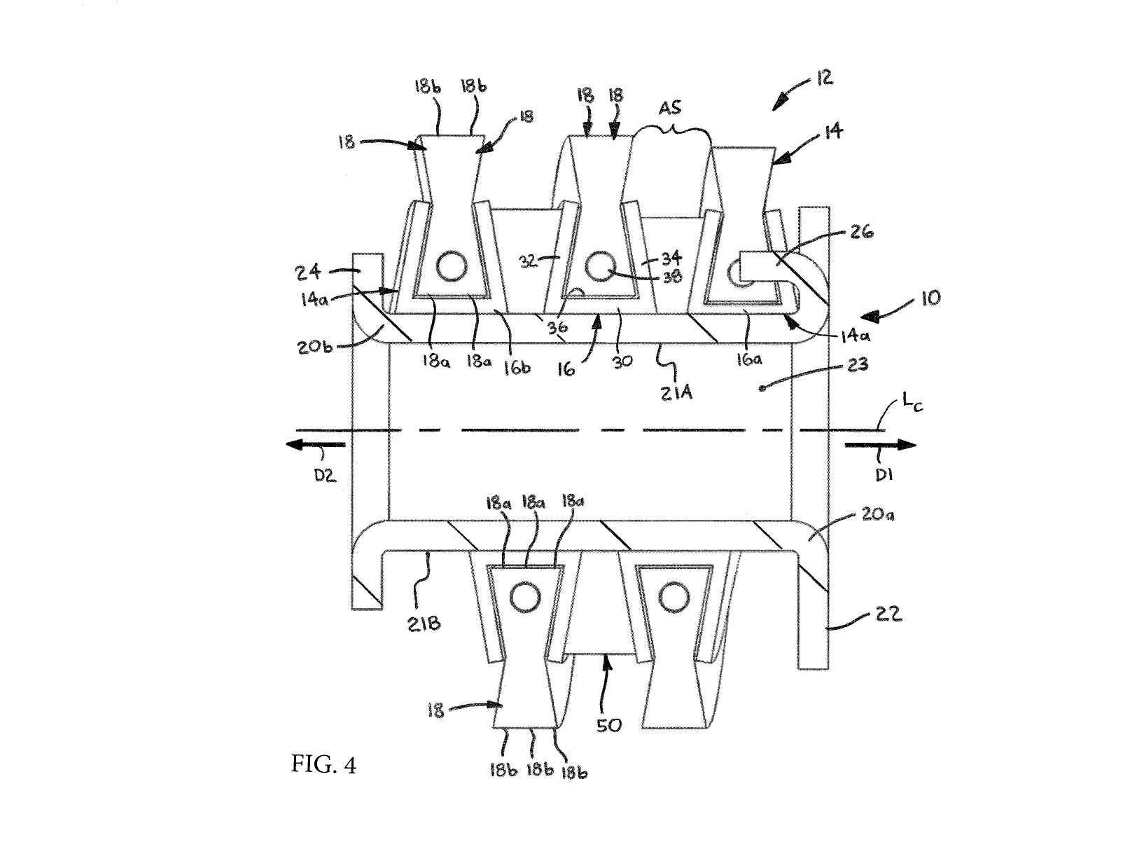

Further, the first flange 22 extends radially outwardly from the first axial end 20a of the base 20 and is engageable with an axial end 14a of the helical brush 14 so as to retain the helical brush 14 disposed about the base 12. In other words, the first flange 22 prevents the brush 14 from axially displacing in a first direction D1 (FIG. 4) along the centerline L_{C} and thereby disengaging from the holder 10. The first flange 22 is preferably integrally formed with the first axial end 20a of the base 20, most preferably by means of a cold forming process, but may alternative be formed by bending or any other appropriate manufacturing technique, or by directly fabricating the tubular base 20 and flange 22, such as for example, by casting, molding, additive manufacturing etc. However, the first flange 22 may alternatively be provided by a separate member, such as an annular washer, attached to the first axial end 14a of the tubular base 20 by any appropriate means, such as threading, welding, etc. Further, the first flange 22 is preferably annular and extends entirely about the centerline L_{C} of the tubular base 20, but may alternatively be formed as two or more arcuate tabs (not shown).

Preferably, the first flange 22 includes a retainer tab portion 26 extending axially from a remainder of the first flange 22 so as to extend over the cylindrical outer surface 21B of the base 20. The tab portion 26 is engageable with the first axial end 16a of the brush retainer 16 to thereby prevent angular displacement of the helical brush 14 about the centerline L_{C}, which may otherwise occur due to vibration, etc. The retainer tab portion 26 is preferably formed by cutting and bending a section of the flange 22 after the flange 22 is formed from a portion of the base 20.

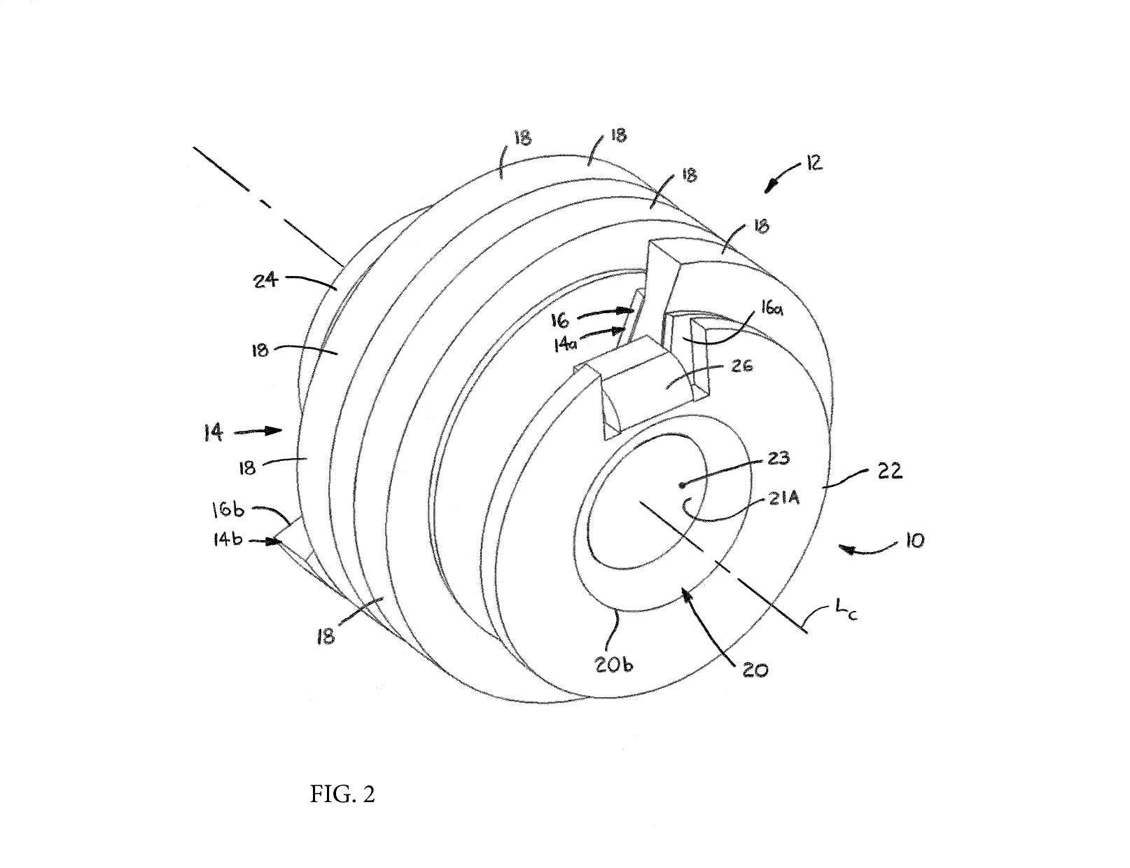

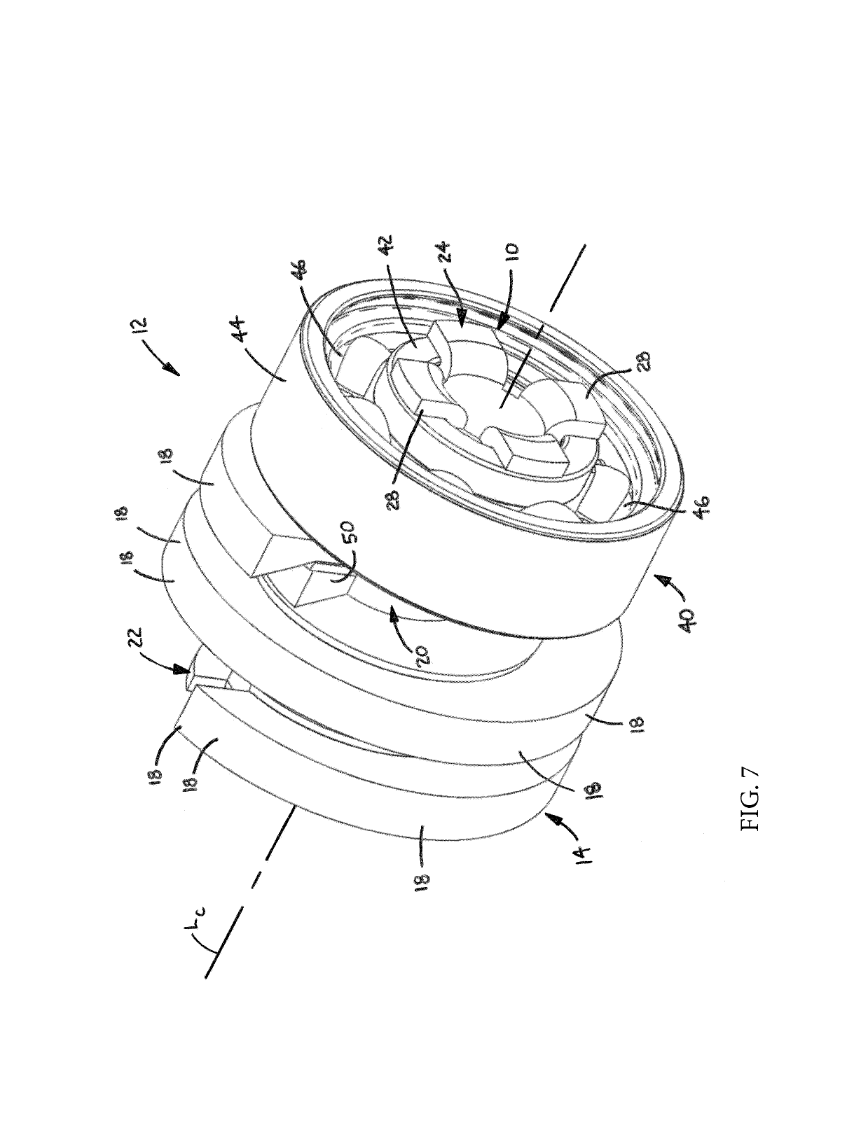

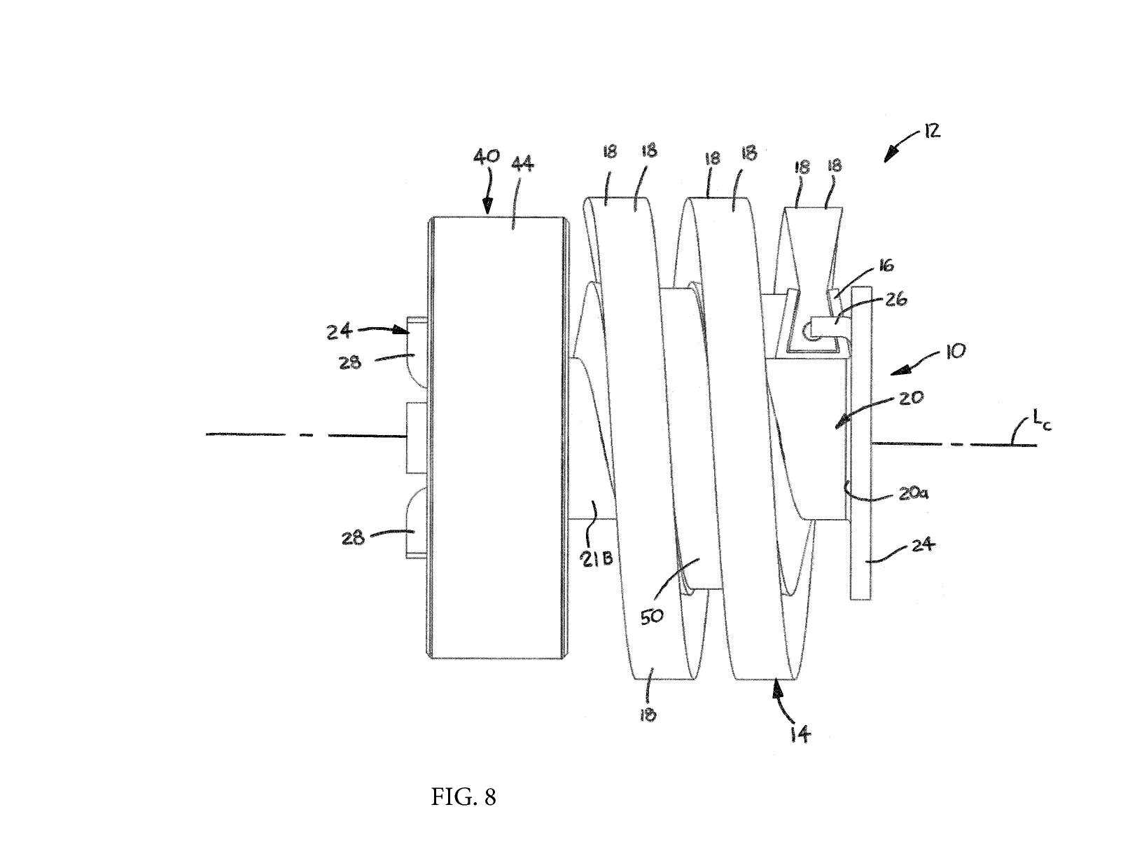

Furthermore, the second flange 24 extends radially outwardly from the second axial end 20b of the base 20 and also retains the helical brush 14 disposed about the base 20. Specifically, the second flange 24 is either engageable with another axial end 16b of the brush retainer 16, as shown in FIGS. 2-5, or with a centering bearing 40 disposed on the tubular base 20 between the helical brush 14 and the second flange 24, as depicted in FIGS. 7 and 8. In either case, the second flange 14 prevents the helical brush 14, and also the bearing 40 in certain embodiments, from axially displacing in a second direction D2 (FIG. 4) along the centerline L_{C} and thereby disengaging from the holder 10.

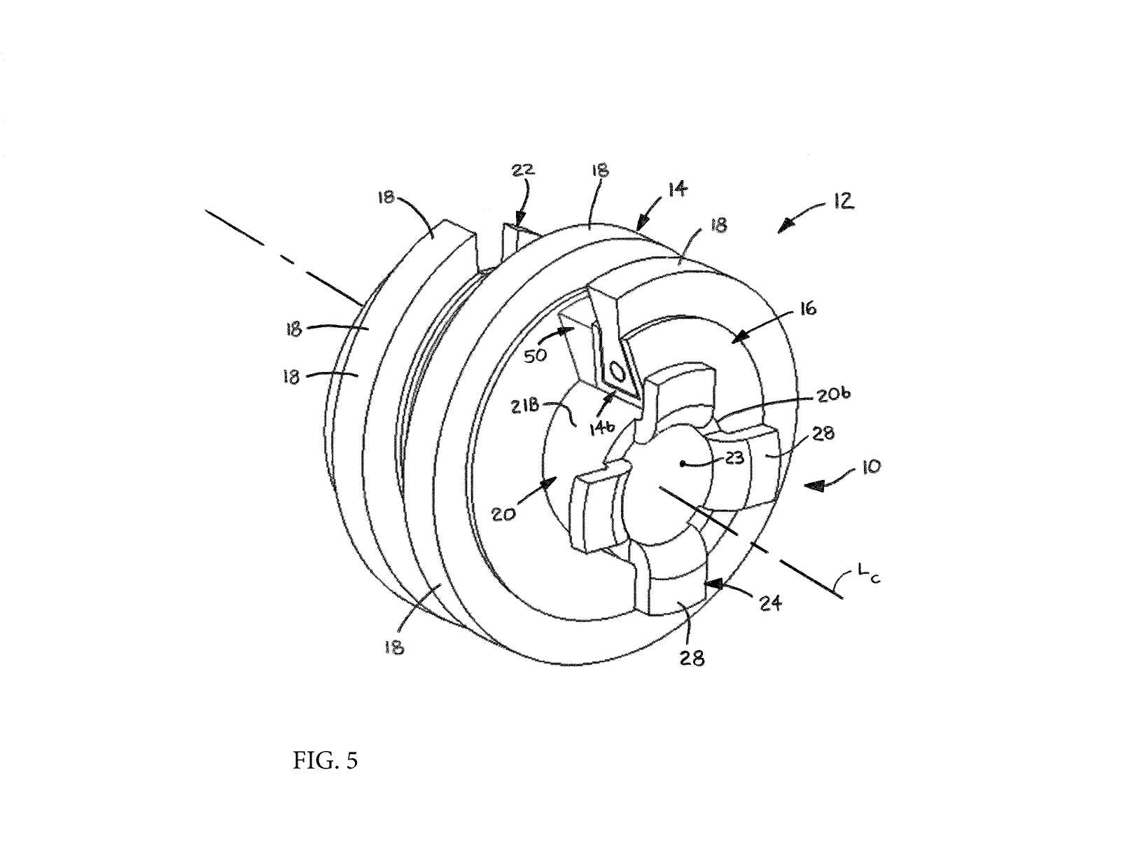

As with the first flange 22, the second flange 24 is also preferably integrally formed with the base 20, specifically the base second axial end 20b, but may alternatively be provided by a separate member attached to the base 20. In any case, the second flange 24 is formed (or attached) after the helical brush 14 (and possibly also the bearing 40) is assembled onto the base 20, as described in further detail below. Preferably, the second flange 24 is formed by bending a portion of the second axial end 20b of the tube 20 radially outwardly, as discussed below. Further, depending on the specific method of forming the flange 24, the second flange 24 is either annular, as shown in FIGS. 2-4, or includes a plurality of arcuate tabs 28 spaced circumferentially about the centerline L_{C}, as depicted in FIGS. 5-8.

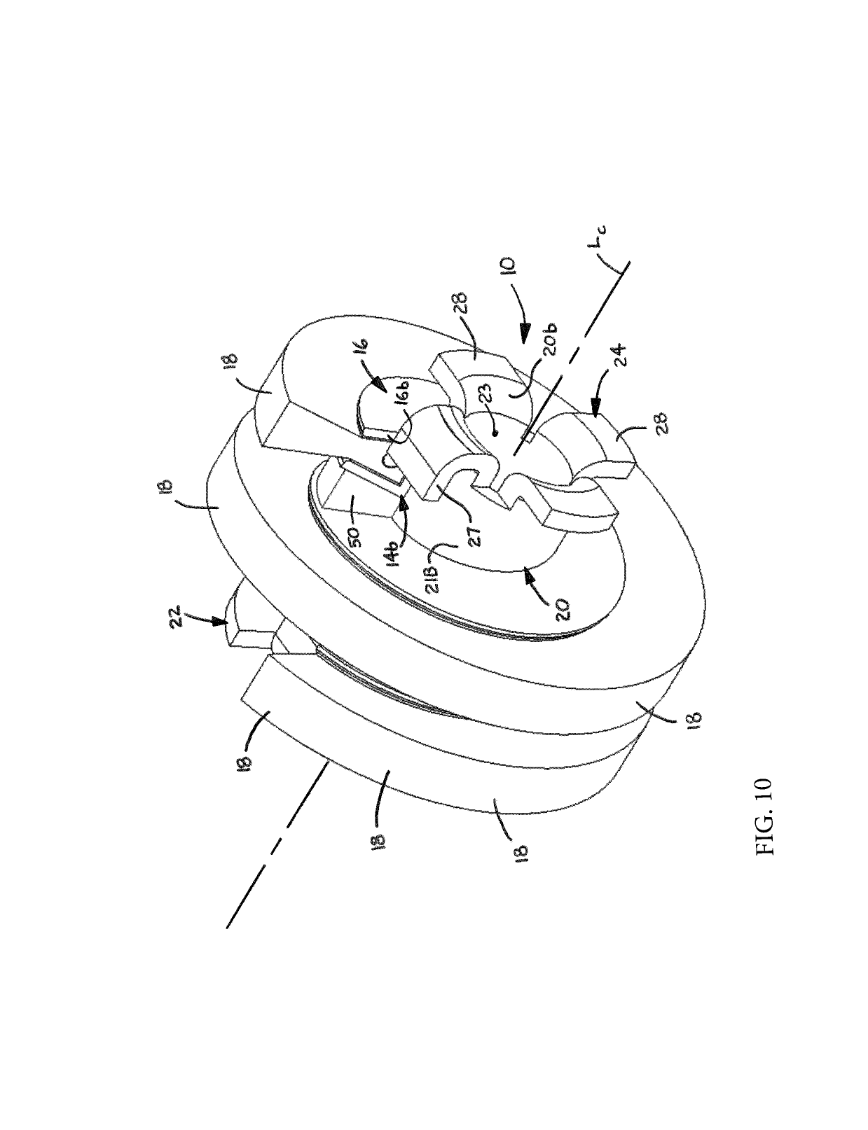

Referring particularly to FIG. 10, when the grounding brush assembly 12 is formed without a centering bearing as discussed below, the second flange 24 may further include another or second retainer tab portion 27 extending axially from a remainder of the second flange 24 so as to extend over the cylindrical outer surface 21B of the base 20. The second retainer tab portion 27 is engageable with the second axial end 16b of the brush retainer 16 to thereby prevent angular displacement of the helical brush 14 about the centerline L_{C}, i.e., in combination with the retainer tab portion 26 of the first flange 22. Preferably, the other/second retainer tab portion 27 is preferably formed by cutting and bending a section of the second flange 22 after the flange 22 is formed, most preferably by providing a second bend in an axial tab 60 as described below.

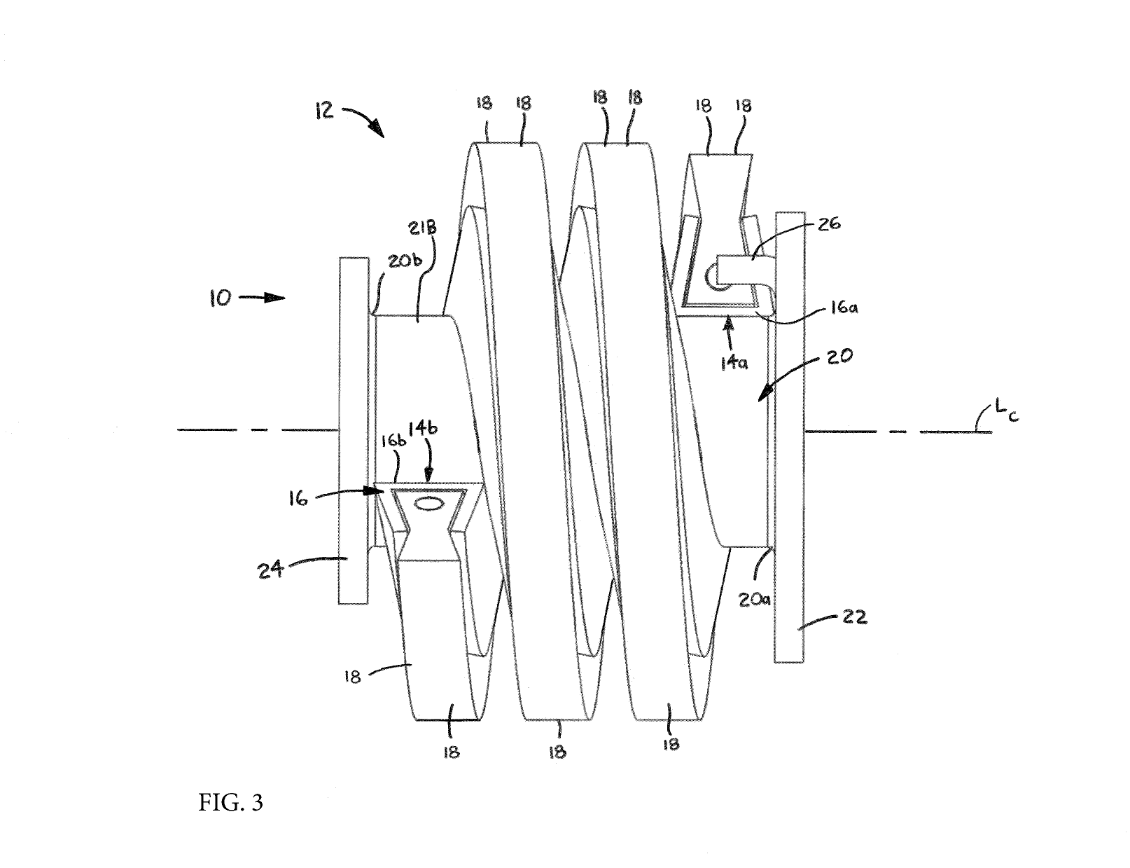

Referring now to FIGS. 3 and 4, as mentioned above, the helical conductive brush 14 basically includes a retainer 16 and a plurality of conductive fibers 18 coupled with and extending radially outwardly from the retainer 16. More specifically, the retainer 16 includes a base wall 30 and two spaced apart side walls 32, 34 extending from the base wall 32 and defining a spiral channel 36. The plurality of conductive fibers 20 are disposed between and engaged or “pinched” by the two side walls 32, 34 so as to retain the fibers 20 within the spiral channel 36. The fibers 20 are distributed along the entire spiral length (not indicated) between the axial ends 16a, 16b of the retainer 16. Further, each conductive fiber 20 has an inner radial end 20a disposed against the base wall 30 of the retainer 16 and an opposing outer radial end engageable with the inner surface 2a of the hollow shaft 2. As such, at least one electrically conductive path extends from the hollow shaft 2, through the helical brush 14 and the holder 10, and to the fixed shaft 6.

Most preferably, the brush 14 further includes a retainer wire 38 extending along the base wall 30 and each conductive fiber 20 is wound about the wire 38. As such, each fiber 18 has a bent section (not indicated) disposed between the retainer wire 38 and the base wall 30 and providing the radial inner end 18a of the conductive fiber 18 and two legs (not indicated) extending radially from the bent portion and providing two outer ends 18b of each conductive fiber 18. Preferably, the retainer 16 is formed of an electrically conductive material, such as for example, steel, aluminum, a conductive polymer, etc., and each conductive fiber 18 is preferably a strand of an electrically conductive material, most preferably carbon, but may be formed of steel, aluminum, a conductive polymer, etc. Further, although the conductive brush 14 preferably includes a plurality of flexible conductive fibers 18 and the retainer 16, the spiral conductive brush 14 may alternatively be formed of one or more spiral-shaped solid conductive members (none shown) coupled with the tubular base 20 and having an outer radial end engageable with the inner surface 2a of the hollow shaft 2.

Referring to FIGS. 7 and 8, in certain constructions, the grounding brush assembly 12 further comprises a centering bearing 40 disposed about the tubular base 20 and located axially between the helical brush 14 and the second flange 24 of the tubular base 20. As such, the second flange 24 engages with the centering bearing 40 to thereby retain both the bearing 40 and the helical brush 14 disposed upon the tubular base 20, as discussed above. The centering bearing 40 includes an inner ring 42 disposed about the tubular base 20 and an outer ring 44 engageable with the inner circumferential surface 2a of the rotatable hollow shaft 2, as shown in FIG. 1. Preferably, the centering bearing 40 also includes a plurality of rolling elements 46 disposed between the inner and outer rings 42, 44, but may be configured as a bushing or plain bearing without any rolling elements. In any case, the centering bearing 40 functions to couple the hollow shaft 2 with the fixed shaft 6 so as to stiffen and prevent vibration of the fixed shaft 6, and does not primarily serve to support any loading between the two shafts 2, 6.

Referring now to FIGS. 4-8, the grounding brush assembly 12 may further comprise at least one spiral spacer ring 50 disposed between at least two loops of the helical brush 14 so as to maintain a desired axial spacing AS between the two loops, as indicated in FIG. 4. The spacer ring(s) 50 functions to maintain a spiral gap between adjacent loops of the brush 14 to allow oil flow around the brush assembly 12. Also, the spacer rings 50 ensure that the two axial ends 14a, 14b of the brush 14 are disposed against the two flanges 22, 24, respectively, or against the first flange 22 and the bearing 40, and that the brush first axial end 14a engages with the retainer tab portion 26 to prevent brush “rotation”. As best shown in FIG. 6, each of the one or more spacer rings 50 has two circumferential ends 50a, 50b which are axially-spaced apart, such that each spacer ring 50 is insertable between loops of the helical brush 14 by “threading” the ring 50 about the tubular base 20. Further, each spacer ring 50 preferably has generally wedge-shaped axial cross-sections which are complementary and inverted with respect to wedge-shaped axial cross-sections of the brush retainer 14, as best shown in FIG. 4.

Having described the basic components of the holder 10 and the grounding brush assembly 12 above, a preferred method of forming the present grounding brush assembly 12 is described as follows. First, the helical conductive brush 14 and a desired length of an elongated circular tube (not shown), which forms the holder 10, are provided. The helical brush 14 may be a sourced item or formed in an appropriate process, the details of which are beyond the scope of the present disclosure. Then, the first flange 22 is formed on the first axial end 20a of the tubular base 20 such that the flange 22 extends radially outwardly from the outer surface 21B of the base 20, preferably by orbital forming or other cold forming process, but any appropriate manufacturing process may be used. After forming the first flange 22, the retainer tab portion 26 is preferably formed by cutting and bending a section of the flange 22, such that the tab portion 26 extends axially over the outer cylindrical surface 21B of the base 20 and toward the base second axial end 20b. Next, the helical brush 14 is axially displaced or “slid” over the second axial end 20b of the tubular base 20 until the brush 14 is disposed entirely about the cylindrical outer circumferential surface 21B of the tubular base 20.

If a centering bearing 40 is included in the grounding brush assembly 12, the bearing 40 is preferably installed on the holder 10 after the brush 14, specifically by inserting the base 20 through the inner ring 42 of the bearing 40, but before the second flange 24 is formed. As such, the bearing 40 is located axially between the helical brush 14 and the second axial end 20b of the tubular base 20. Then, after brush installation, the second flange 24 is formed on the second axial end 60b of the tube 60 such that the second flange 24 extends radially outwardly from the outer surface 62 of the tube 60. The second flange 24 may be formed by cold forming, e.g., orbital forming, or may be formed by bending.

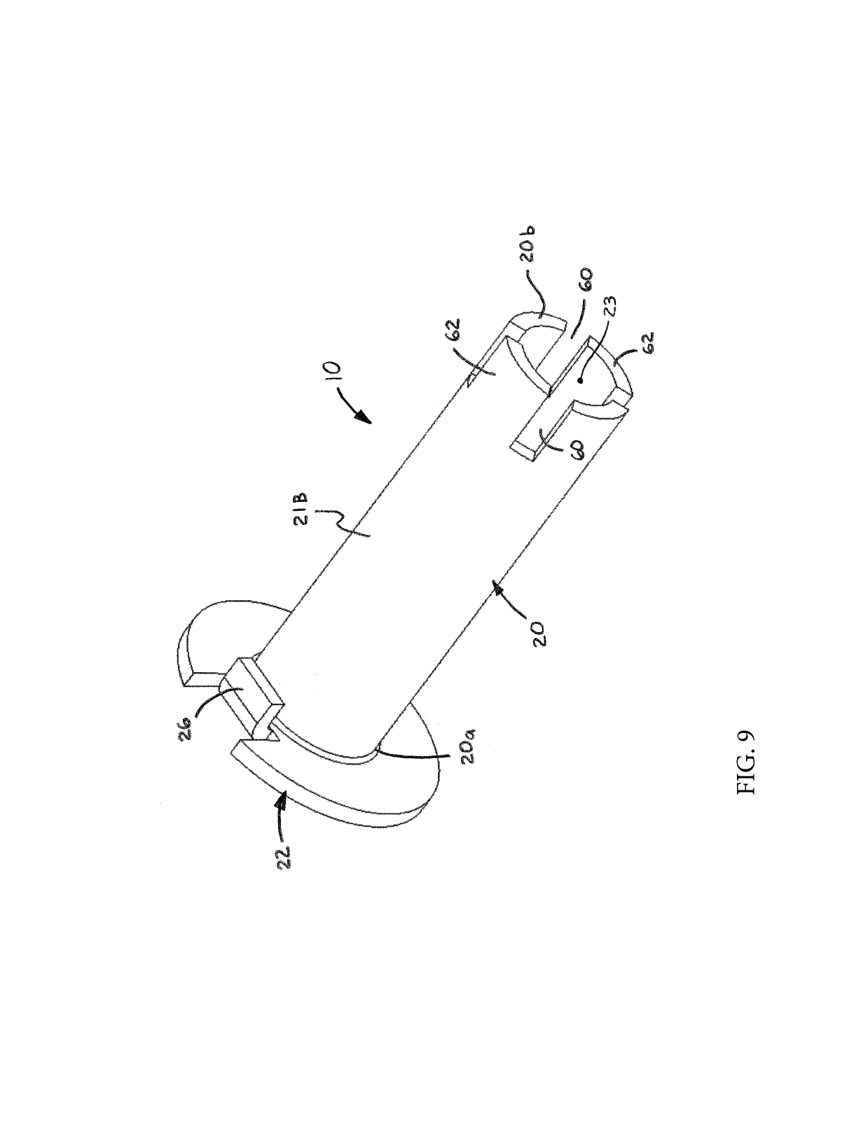

When it is desired to form the second flange 24 by bending, the present method further comprises a step of forming a plurality of axial slotted openings 60 extending axially from the second axial end 20b of the tubular base 20 so as to define a plurality of axial tabs 62, as shown in FIG. 9. The slotted openings 60 are either formed prior to or after forming the first flange 22, but are preferably formed before the installation of the helical brush 14 on the base 20. In any case, each one of the axial tabs 62 is bent radially outwardly and thereby form the second flange 24, such that the first and second flanges 22, 24 retain the helical brush 14, and possibly also the bearing 40, about the base 20. If another or second retainer tab portion 27 is desired, one of the axial tabs 62 may be provided with a second bend such that the tab portion 27 is formed and extends axially toward the first flange 22.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A holder for a grounding brush assembly for an electric machine, the grounding brush assembly including a helical conductive brush with a helical retainer having opposing axial ends and a plurality of electrically conductive fibers extending radially outwardly from the retainer, the electric machine including a hollow shaft, the hollow shaft being rotatable about a central axis and having a bore, and a fixed shaft extending through the bore of the hollow shaft, the holder comprising:
a circular tubular base having a centerline, a first axial end and second axial end spaced apart along the centerline, an inner circumferential surface extending between the first and second axial ends and defining a bore configured to receive a portion of the fixed shaft, and a cylindrical outer circumferential surface extending between the first and second axial ends and sized to receive the helical brush;
a first flange extending radially outwardly from the first axial end of the base and engageable with an axial end of the helical brush so as to retain the helical brush disposed about the base; and
a second flange extending radially outwardly from the second axial end of the base and engageable with another axial end of the helical brush or a centering bearing disposed on the base between the helical brush and the second flange to retain the helical brush disposed about the base.

2. The holder as recited in claim 1, wherein the first flange is integrally formed with the first axial end of the base and the second flange is integrally formed with the second axial end of the base.

3. The holder as recited in claim 1, wherein the second flange is bent radially outwardly from the second axial end of the tubular base after installation of the helical brush about the base.

4. The holder as recited in claim 1, wherein the first flange includes a retainer tab portion extending axially from a remainder of the first flange and engageable with the first axial end of the brush retainer so as to prevent angular displacement of the helical brush about the centerline.

5. The holder as recited in claim 4, wherein the second flange includes a retainer tab portion extending axially from a remainder of the second flange and engageable with the second axial end of the brush retainer so as to prevent angular displacement of the helical brush about the centerline.

6. The holder as recited in claim 1, wherein the cylindrical outer surface of the base has an outside diameter greater an inside diameter of the helical brush.

7. The holder as recited in claim 1, wherein:
the first flange is annular; and
the second flange is annular or includes a plurality of arcuate tabs spaced circumferentially about the centerline.

8. A grounding brush assembly for an electric machine including a hollow shaft, the hollow shaft being rotatable about a central axis and having an inner circumferential surface defining a bore, and a fixed shaft extending through the bore of the hollow shaft, the grounding brush assembly comprising:
a holder including a circular tubular base, the base having a centerline, a first axial end and second axial end spaced apart along the centerline, an inner circumferential surface defining a circular bore configured to receive a portion of the fixed shaft, and a cylindrical outer circumferential surface, a first flange integrally formed with and extending radially outwardly from the first axial end of the base and a second flange integrally formed with and extending radially outwardly from the second axial end of the base; and
a helical conductive brush disposed about the cylindrical outer surface of the tubular base between the first and second flanges, the brush including a helical retainer and a plurality of electrically conductive fibers extending radially outwardly from the retainer and engageable with the inner circumferential surface such that at least one electrically conductive path extends from the hollow shaft, through the helical brush and the holder, and to the fixed shaft.

9. The grounding brush assembly as recited in claim 8, wherein the second flange is formed after the helical brush is installed about the cylindrical surface of the base.

10. The grounding brush assembly as recited in claim 8, wherein:
the first flange is engageable with an axial end of the helical brush so as to retain the helical brush disposed about the base; and
the second flange is engageable with another axial end of the helical brush or a centering bearing disposed on the base between the helical brush and the second flange to retain the helical brush disposed about the base.

11. The grounding brush assembly as recited in claim 8, wherein the first flange includes a retainer tab portion extending axially from a remainder of the first flange and engageable with the first axial end of the brush retainer so as to prevent angular displacement of the helical brush about the centerline.

12. The holder as recited in claim 11, wherein the second flange includes a retainer tab portion extending axially from a remainder of the second flange and engageable with the second axial end of the brush retainer so as to prevent angular displacement of the helical brush about the centerline.

13. The grounding brush assembly as recited in claim 8, wherein:
the first flange is annular; and
the second flange is annular or includes a plurality of arcuate tabs spaced circumferentially about the centerline.

14. The grounding brush assembly as recited in claim 8, further comprising a centering bearing disposed about the tubular base between the helical brush and the second flange of the tubular base.

15. The grounding brush assembly as recited in claim 8, further comprising at least one spiral spacer ring disposed between two loops of the helical brush so as to maintain a desired axial spacing between the two loops.

16. A method of forming a grounding brush assembly, the method comprising the steps of:
providing a helical conductive brush including a helical retainer and a plurality of conductive fibers extending radially outwardly from the retainer;
providing an elongated circular tube having a centerline, opposing first and second axial ends, an inner circumferential surface defining a circular bore, and an outer circumferential surface;
forming a first flange on the first axial end of the tube such that the first flange extends radially outwardly from the outer surface of the tube;
axially displacing the helical brush over the second axial end of the tube until the brush is disposed entirely about the outer circumferential surface of the tube;
forming a second flange on the second axial end of the tube such that the second flange extends radially outwardly from the outer surface of the tube, the first and second flanges retaining the helical brush about the tube.

17. The method as recited in claim 16, wherein the first flange is formed by cold forming and the second flange is formed by cold forming or bending.

18. The method as recited in claim 16, wherein:
the method further comprises the step of forming a plurality of axial slotted openings extending axially from the second axial end of the tube so as to define a plurality of axial tabs; and
the step of forming the second flange includes bending each one of the axial tabs radially outwardly.

19. The method as recited in claim 16, further comprising the step of cutting and bending a portion of the first flange so as to form an axial retainer engageable with one axial end of the grounding brush so as to prevent angular displacement of the grounding brush about the centerline of the base.

20. The method as recited in claim 16, further comprising the steps of:
providing a centering bearing; and
installing the centering bearing about the tubular base axially between the helical brush and the second axial end of the tubular base before the step of forming the second flange.
